(19) United States
(12) Patent Application Publication
(10) Pub. No.: US 2004/0064999 A1
(43) Pub. Date: Apr. 8, 2004

(54) Center-weighted shank fish hooks

(76) Inventor: Wayne J. Falcon, Lafayette, LA (US)

Correspondence Address: HAYNES AND BOONE, LLP, 901 MAIN STREET, SUITE 3100, DALLAS, TX, 75202, US

(21) Appl. No.: 10/655,446

(22) Filed: Sep. 4, 2003

Related U.S. Application Data
(60) Provisional application No. 60/407,807, filed on Sep. 4, 2002.

(51) Int. Cl. A01K 83/06

(52) U.S. Cl. 43/44.2

(57) ABSTRACT

Weighted fish hooks having a hook shank having a bend at one end and a hook eye at an opposite end. A double-tapered weight having a top weight taper and a lower weight taper is provided on the hook shank between the bend and the hook eye.

### BACKGROUND OF THE INVENTION

1. Field of the Invention

This invention relates to fishing lures and more particularly, to specially designed fish hooks, each having a low profile, double-tapered weight on the hook shank for use with flexible plastic fishing lures. These lures are impaled on an offset shank and reverse shank bend of the fish hooks, such that the tip and barb of the fish hooks may be embedded in or positioned against the plastic fishing lures to render the lures weedless for retrieval in a waterbody using a rod and reel. In a preferred embodiment a straight shank upper center-weighted fish hook is provided, wherein a low profile, double-tapered weight is applied to the upper center segment of the straight shank of the hook to facilitate passage of the weight through the impaled lure with minimum lure damage during rigging and sinking of the hook and impaled lure to a desired depth determined by the lure design and speed of retrieval of the lure. In another preferred embodiment of the invention a curved shank upper center-weighted fish hook is provided with a low profile, double-tapered weight attached to the upper portion of the curved shank and the hook is adapted for partial embedment in a flexible plastic fishing lure to achieve the same result.

2. Description of the Prior Art

One of the most effective lures in taking game fish, including the fresh water variety such as large mouth and small mouth bass, crappie and the like, as well as saltwater varieties, including red fish, speckled trout and similar fish, is the flexible plastic lure which can be molded in substantially any desired size, shape, color and consistency. A popular technique for retrieving plastic fishing lures at a desired depth in a waterbody is to embed a hook in the soft plastic of the fishing lure and place a weight or sinker on the line or on the hook shank, typically at the very top or bottom thereof, to cause the flexible plastic fishing lure to sink to a desired depth before and during retrieval. Retrieval of flexible plastic fishing lures rigged in this manner is typically effected by initially lifting, and subsequently lowering the tip of the fishing rod and intermittently operating the reel to facilitate raising and falling of the lure, causing the flexible plastic fishing lure to assume a swimming appearance. Accordingly, the action of the weight on the hook allows the lure to be fished directly on the bottom of the waterbody, where the lure is typically bounced off the bottom in a swimming or crawling simulation, or fished at the surface or an intermediate depth, depending upon the lure design and speed of retrieval. Problems with conventional sinkers and weights attached to the fishing line and the shanks of the hooks in prior art hooks include snagging or catching of the sinker on underwater obstacles such as moss, rocks, tree limbs, stumps, grass, weeds and the like when a lure is fished on the bottom and improper balancing of the impaled lure in the water during retrieval. The balancing problem includes excessive rate of sinking in the case of slip sinkers placed on the fishing line and excessive weight of improper shape placed on the hook shank in the wrong place.

Typical of the prior art weighted hook devices is the “Mustad FIN-ACKY” (trademark) which includes a straight shank that curves to a reverse bend for embedment in the plastic fishing lure and includes a weight added to the top of the hook shank for causing the weighted fishing lure to sink to a desired depth in a waterbody. An early fishing line hook and sinker is detailed in U.S. Pat. No. 83,681, patented Nov. 3, 1868. Other patents detailing various types of hooks with sinkers include U.S. Pat. No. 148,926, patented Mar. 24, 1874 to M. V. Cahon; U.S. Pat. No. 1,295,370, patented Feb. 25, 1919 to F. A. Porter; U.S. Pat. No. 167,687, dated Sep. 14, 1875, to Pitcher; U.S. Pat. No. 2,185,666, patented Jan. 2, 1940 to A. D. Hill, Jr.; U.S. Pat. No. 2,775,842, dated Jan. 1, 1957, to T. McCade; U.S. Pat. No. 4,819,366, patented Apr. 11, 1989 to J. T. Manno; U.S. Pat. No. 5,220,743, dated Jun. 22, 1993, to McClellan; and U.S. Pat. No. 5,901,494, dated May 11, 1999 to Herb Reed.

It has been found in the course of this invention that a low-profile, double-tapered weight can be added to the upper center segment of a curved or straight shank fishing hook, and an offset shank, reverse-bend fishing hook in particular, to facilitate embedment of portions of the hook in a flexible plastic fishing lure, and fishing of the hook and lure at a desired depth in an easily controlled manner, by varying the speed of retrieval of the lure. It has further been found that the low profile, double-tapered, upper center-located weight serves the purpose of improving the lure rigging and preventing, or at least greatly minimizing, snagging of the lure and the partially embedded hook on underwater obstacles such as moss, weeds, rocks, tree limbs and the like, and facilitates a much smoother retrieval, whether the lure is being bounced off the bottom in heavy brush, rocks or the like, or retrieved on the surface or at an intermediate depth through the waterbody. Furthermore, placement of the streamlined, low-profile double-tapered weight on the hook shank near the shank offset bend effects a surprisingly natural sinking of the hook-impaled lure, slightly head-down and with a slow descent, as well as a more natural “swimming action” of the lure due to minimum water resistance from the double-tapered, low profile weight.

It is therefore an object of this invention to provide new and improved, upper center-weighted fish hooks, which hooks include a double-tapered weight attached to the shank for causing the hooks and lures in which the hooks are partially embedded, to sink at a desired rate to a desired retrieval depth, which depth is determined primarily by the weight, size and speed of retrieval of the hooks and lures through a waterbody.

Another object of this invention is to provide a straight shank upper center-weighted fish hook for embedment in the body portion of a flexible plastic fishing lure such as a flexible plastic worm, which hook includes a straight shank fitted with a low profile, double-tapered weight at the upper center thereof, an extended shank bend provided in the lower portion of the straight shank to define an extended shank, with a reverse bend provided in the extended shank to define a reverse bend neck, a hook tip and a hook barb. At the opposite end of a straight shank above the weight there is provided an offset shank defined by a shank offset bend that defines the shank offset, and a shank neck bend that terminates in a hook eye.

Yet another object of this invention is to provide a curved shank upper center-weighted fish hook for partial embedment in flexible plastic fishing lures such as flexible plastic worms, which fish hook includes a curved shank segment fitted with a low profile, double-tapered weight at the upper center thereof. A reverse bend terminates the curved shank to define a reverse bend neck, which terminates in a hook tip and a hook barb. The opposite or upper end of the curved shank, like the straight shank upper center-weighted fish hook, terminates in a shank offset bend, a shank offset, a shank neck bend and a shank neck, which terminates in a hook eye.

### SUMMARY OF THE INVENTION

These and other objects of the invention are realized in new and improved center-weighted fish hooks which include in a first preferred embodiment, a straight shank upper center weighted fish hook for partial embedment in the head and body portion of a flexible plastic fishing lure such as a flexible plastic worm, which hook includes a straight shank fitted with a streamlined, low profile, double-tapered weight at the upper center thereof, an extended shank bend provided in the lower portion of the straight shank to define an extended shank, with a reverse bend provided in the extended shank to define a reverse bend neck, hook top and hook barb. At the opposite end of the straight shank and above the weight there is provided a shank offset bend that defines a shank offset, a shank neck bend and a shank neck that terminates in a hook eye.

In a second preferred embodiment of the invention a curved shank upper center-weighted fish hook is provided for partial embedment in flexible plastic fishing lures such as flexible plastic worms, which fish hook includes a curved shank segment fitted with a streamlined, low profile, double-tapered weight at the upper center thereof. A reverse bend terminates the lower end of the curved shank to define a reverse bend neck, which terminates in a hook tip and a hook barb. The opposite, upper end of the curved shank, like the straight shank upper center-weighted fish hook, terminates in a shank offset bend, a shank offset, a shank neck bend, and a shank neck, which terminates in a hook eye.

### BRIEF DESCRIPTION OF THE DRAWINGS

The invention will be better understood by reference to the accompanying drawings, wherein:

FIG. 1 is a side view of the straight shank upper center-weighted fish hook of this invention;

FIG. 2 is a side view of the straight shank upper center-weighted fish hook illustrated in FIG. 1, more particularly showing the fish hook partially embedded in a flexible plastic fishing worm rigged in a weedless configuration;

FIG. 3 is a side view of a curved shank upper center-weighted fish hook of this invention; and

FIG. 4 is a side view of the curved shank center-weighted fish hook illustrated in FIG. 3, more particularly showing the fish hook partially embedded in a flexible plastic fishing lure in a weedless configuration.

### DESCRIPTION OF THE PREFERRED EMBODIMENTS

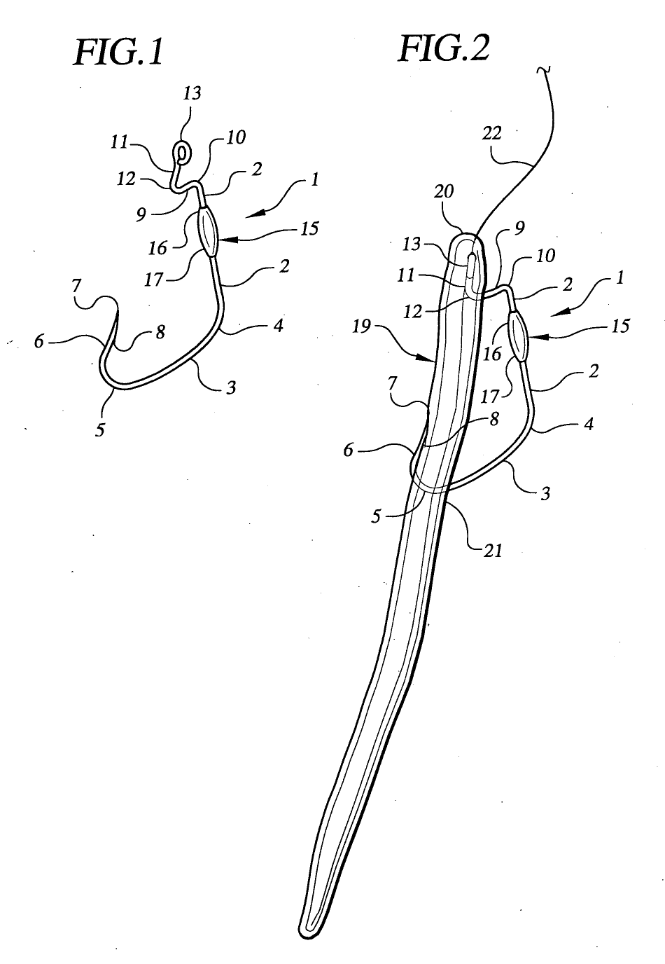

Referring initially to FIGS. 1 and 2 of the drawings, in a first preferred embodiment of the invention, a straight upper center-weighted fish hook is generally designated by reference numeral 1. The straight shank upper center-weighted fish hook 1 is characterized by a straight shank 2 that curves to define an extended shank 3 at an extended shank bend 4. The extended shank bend 4 continues, defining a reverse bend 5, and a reverse bend neck 6 that extends from the reverse bend 5 and terminates at a sharp hook tip 7. An optional hook barb 8 is provided in the reverse bend neck spaced from the hook tip 7, as further illustrated in FIG. 1. The straight shank 2 continues in the opposite direction from the extended shank bend 4 to define a shank offset 9 at a shank offset bend 10, and the shank offset 9 curves at a shank neck bend 12 to define a shank neck 11, terminated by a hook eye 13, to which a fishing line 22 is tied, as illustrated in FIG. 2. A double-tapered, low profile weight 15, having a top weight taper 16 and a bottom weight taper 17, each tapered to the upper center segment of the straight shank 2 is provided, such that the top weight taper 16 is spaced from, but near, the shank offset bend 10.

As further illustrated in FIG. 2 the straight shank upper center-weighted fish hook 1 is typically initially threaded through the lure head 20 of a plastic worm lure 19, with minimum lure head 20 damage, due to the top weight taper 16 and bottom weight taper 17 of the double-tapered weight 15. After the fishing line 22 is tied to the hook eye 13, the straight shank fish hook 1 is embedded in the plastic worm lure 19 such that the hook eye 13, the shank neck 11, and the shank neck bend 12 are embedded in the lure head 20 and the shank offset 9 extends from the lure head 20. The lower portion of the straight shank upper center-weighted fish hook 1, including the reverse bend 5 and a portion of the extended shank 3 is then embedded in the lure body 21 of the plastic worm lure 19, as further illustrated in FIG. 2. In a preferred embodiment, this embedment is effected such that the reverse bend neck 6 typically extends alongside the soft plastic contour of the typically straight lure body 21 of the plastic lure 19 and the hook tip 7 terminates adjacent to, or is typically slightly embedded in, the lure body 21, along with the optional hook barb 8, which facilitates retrieval of the plastic worm lure 19 with the partially embedded straight shank upper center-weighted fish hook 1 through a waterbody, across and through obstacles such as moss and weeds, and around or over submerged tree limbs and stumps and the like, in a weedless fashion, without engaging the hook tip 7 with the underwater obstacles. Furthermore, as illustrated in FIG. 2, the extending portion of the shank offset 9, the shank offset bend 10, the straight shank 2, the double-tapered weight 15 and the extended shank bend 4, as well as a portion of the extended shank 3 are not embedded in the plastic worm lure 19. The double-tapered weight 15 is exposed to the waterbody and is positioned on the upper segment of the straight shank 2 to facilitate an optimum sinking rate and a natural swimming appearance of the plastic worm lure 19.

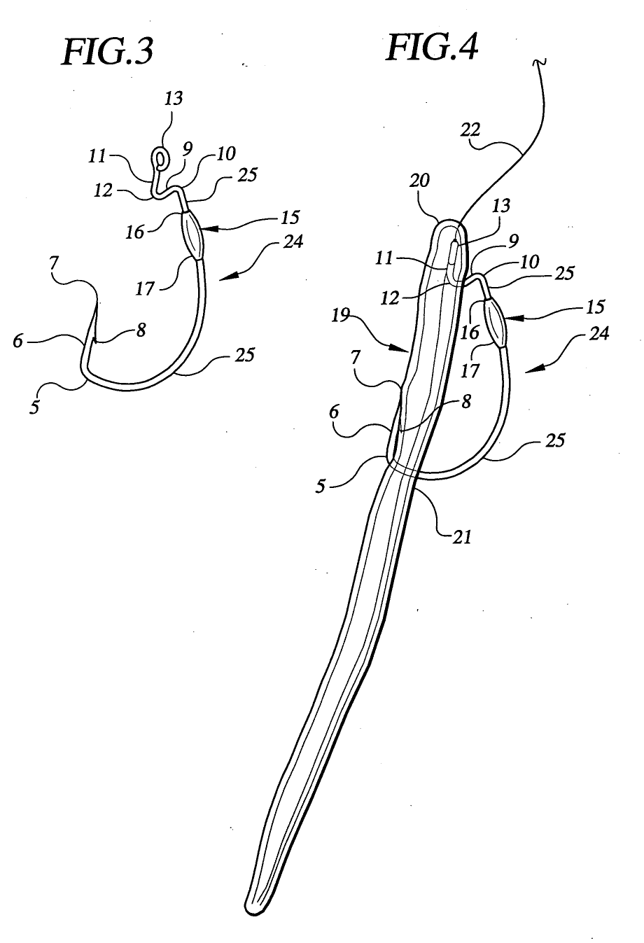

Referring now to FIGS. 3 and 4 of the drawings in another preferred embodiment of the invention a curved shank upper center-weighted fish hook 24 is illustrated and includes a curved shank 25 that extends at one end to define a reverse bend neck 6 at a reverse bend 5. As in the case of the straight shank upper center-weighted fish hook 1 illustrated in FIGS. 1 and 2, the reverse bend neck 6 in the curved shank upper center-weighted fish hook 24 terminates in a sharp hook tip 7 and in an optional hook barb 8, as illustrated. The curved shank 25 extends in the opposite direction from the reverse bend 5 to define a shank offset 9 at a shank offset bend 10, and includes a shank neck bend 12 and a shank neck 11, terminated by a hook eye 13 in the same manner as the straight shank upper center-weighted fish hook 1 illustrated in FIGS. 1 and 2. A low profile double-tapered weight 15 is provided on the upper end of the curved shank 25 and includes a top weight taper 16 and a bottom weight taper 17, which top weight taper 16 is situated a short distance from the shank offset bend 10, as illustrated in FIG. 3.

Referring again to FIG. 4 of the drawings, the curved shank upper center-weighted fish hook 24 is typically embedded in the lure head 20 and lure body 21 of the plastic worm lure 19 in essentially the same manner as the straight shank upper center-weighted fish hook 1, with minimum damage to the lure head 20, as described above. Accordingly, the reverse bend neck 6 and the hook tip 7 are typically positioned to lie alongside the lure body 21 of the plastic worm lure 19 to render the plastic worm lure 19 and curved shank upper center-weighted fish hook 24 essentially weedless as it is pulled through submerged weed beds and moss and over and around limbs, tree stumps and the like, by means of the fishing line 22 which is attached to a conventional reel (not illustrated). Further, as above described with respect to the straight shank upper center-weighted fish hook 1 illustrated in FIGS. 1 and 2, the plastic worm lure 19 is designed to sink at a natural rate of descent due to the position, size and shape of the double-tapered weight 15.

Referring again to FIGS. 1-4 of the drawings, when the straight shank upper center-weighted fish hook 1 and curved shank center-weighted fish hook 24 are partially embedded in the plastic worm lure 19 as illustrated in FIGS. 2 and 4, and the fishing line 22 is tied to each hook eye 13 prior to such embedment, it will be appreciated by those skilled in the art that each hook and lure combination may be cast from a casting rod and reel (not illustrated) upon which reel and fishing line 22 is wound. The plastic worm lure 19 and embedded straight shank upper center-weighted fish hook I and curved shank upper center-weighted fish hook 24, respectively, can be retrieved through a waterbody, either on the surface, on the bottom or at a selected depth, since the plastic worm lure 19 will sink naturally as a result of the double-tapered weight 15. Furthermore, under circumstances where the straight shank center-weighted fish hook 1 and curved shank upper center-weighted fish hook 24 encounter moss, weeds or underwater obstacles such as limbs and the like, the top weight taper 16 and the bottom weight taper 17 on the double-tapered weight 15 in each case facilitate a low profile for easy slipping through the weeds or moss, and over and around limbs to minimize entanglement of the plastic worm lure 19, the straight shank center-weighted fish hook 1, and the curved shank upper center-weighted fish hook 24 in the underwater obstacles. This streamlined, low profile of the double-tapered weight 15 in each case also facilitates a more natural retrieval of the plastic worm lure 19 since it offers minimum resistance to water pressure and does not materially interfere with the natural “swimming” action and movement of the plastic worm lure 19 through the water.

Referring again to the drawings it will be appreciated by those skilled in the art that a primary consideration of both the straight shank upper center-weighted fish hook 1 and the curved shank upper center-weighted fish hook 24 is the positioning and location, as well as the streamlined profile and shape of the double-tapered weight 15 in each case. The double-tapered weight 15 includes a top weight taper 16 and bottom weight taper 17 to facilitate easy, weedless retrieval of the straight shank upper center-weighted fish hook 1 illustrated in FIG. 2 and the curved shank upper center-weighted fish hook 24 illustrated in FIG. 4, when partially embedded in a plastic worm lure 19. Furthermore, the position of the double-tapered weight 15 slightly below the shank offset bend 10 in both of the straight shank upper center-weighted fish hook 1 and curved shank upper center-weighted fish hook 24 illustrated in FIGS. 2 and 4, respectively, facilitates an optimum angle of position and rate of descent as the plastic worm lure 19 sinks in a waterbody, to be attractive to fish. Accordingly, when cast and before retrieval, the plastic worm lure 19 illustrated in FIGS. 2 and 4 will not dive rapidly toward the water bottom, nor will it float tail down or horizontally toward the waterbody, but it will slowly sink with the lure head 20 positioned in a naturally-appearing, downward position and the lure body 21 following in an optimum undulating simulated swimming action designed to attract fish. Moreover, the low profile configuration of the exposed double-tapered weight 15 does not interfere with the naturally-appearing “swimming” action of the plastic worm lure 19 during all types of retrieval.

It will be appreciated by those skilled in the art that the straight shank upper center-weighted fish hook 1 and the curved shank upper center-weighted fish hook 24 can be constructed in any desired size or “number”, as fish hooks are numbered in the art, with a double-tapered weight 15 (typically, but not necessarily constructed of lead) of corresponding size and weight provided on the upper segments of the straight shank 2 and the curved shank 25, respectively. Moreover, regardless of the selected size of the double-tapered weight 15, it should be provided with a top weight taper 16 and a bottom weight taper 17 to facilitate weedless action of the plastic worm lure 19 illustrated in FIGS. 2 and 4, as well as streamlined retrieval action. It will be further appreciated by those skilled in the art that both the straight shank fish hook 1 and the curved shank fish hook 24 may be mounted on a wide variety of plastic fishing lures, including worms, lizards, grubs, crawfish, shad and other lures and baits of all descriptions, in non-exclusive particular, typically, but not necessarily, in the manner illustrated in FIGS. 2 and 4 of the drawings. Accordingly, as desired, the straight shank upper center-weighted fish hook 1 and curved shank upper center-weighted fish hook 24 may be adjusted in the lure head 20 and lure body 21 of the plastic worm lure 19, such that the hook tip 7 penetrates the lure body 21 to insure that both the hook tip 7 and the hook barb 8 are hidden and free from entanglement in or snagging on underwater obstacles while the plastic worm lure 19 is retrieved.

While the preferred embodiments of the invention have been described above, it will be recognized and understood that various modifications may be made in the invention and the appended claims are intended to cover all such modifications which may fall within the spirit and scope of the invention.

What is claimed is:

1. An upper center-weighted hook for partial embedment in a plastic fishing lure and retrieval through a waterbody, said hook comprising:
a hook shank for extending into the lure;
a bend provided in one end of said hook shank;
a hook tip terminating said bend;
a hook eye provided on an opposite end of said hook shank from said bend; and
a double-tapered weight provided on said shank, said weight spaced from said hook eye for causing said hook and the lure to sink in the waterbody.

2. The upper-center weighted hook of claim 1 wherein said hook shank is substantially straight from above said bend to at least immediately above said weight.

3. The upper center-weighted hook of claim 1 wherein said hook shank is curved from said bend at least to said weight.

4. The upper center-weighted hook of claim 1 further comprising:
an offset bend provided in said shank between said weight and said hook eye.

5. The upper-center weighted hook of claim 4 wherein said hook shank is substantially straight from above said bend to at least immediately above said weight.

6. The upper center-weighted hook of claim 4 wherein said hook shank is curved from said bend at least to said weight.

7. The upper center-weighted hook of claim 4 further comprising:
a reverse bend provided in said bend and wherein said hook tip terminates said reverse bend.

8. The upper-center weighted hook of claim 7 wherein said hook shank is substantially straight from above said bend to at least immediately above said weight.

9. The upper center-weighted hook of claim 7 wherein said hook shank is curved from said bend at least to said weight.

10. The upper center-weighted hook of claim 7 further comprising:
a barb provided in said reverse bend, said barb spaced from said hook tip.

11. The upper-center weighted hook of claim 10 wherein said hook shank is substantially straight from above said bend to at least immediately above said weight.

12. The upper center-weighted hook of claim 10 wherein said hook shank is curved from said bend at least to said weight.

13. The upper-center weighted hook of claim 1 further comprising:
a reverse bend provided in said bend, wherein said hook tip terminates said reverse bend.

14. The upper-center weighted hook of claim 13 wherein said hook shank is substantially straight from above said bend to at least immediately above said weight.

15. The upper center-weighted hook of claim 13 wherein said hook shank is curved from said bend at least to said weight.

16. The upper-center weighted hook of claim 13 further comprising:
a barb provided in said reverse bend, said barb spaced from said hook tip.

17. The upper-center weighted hook of claim 16 wherein said hook shank is substantially straight from above said bend to at least immediately above said weight.

18. The upper center-weighted hook of claim 16 wherein said hook shank is curved from said bend at least to said weight.

19. An upper center-weighted hook for partial embedment in a plastic fishing lure, said hook comprising:
a straight hook shank segment;
a bend provided in one end of said straight hook shank segment;
a reverse bend terminating said bend;
a hook tip terminating said reverse bend;
a hook eye provided on an opposite end of said straight hook shank segment from said bend; and
a double-tapered weight provided on said straight shank segment, said weight spaced from said hook eye for causing said hook and the lure to sink in a waterbody.

20. The upper center-weighted hook of claim 19 further comprising:
an offset bend provided in said straight shank segment between said weight and said hook eye.

21. The upper center-weighted hook of claim 19 further comprising a barb provided in said reverse bend, said barb spaced from said hook tip.

22. The upper center-weighted hook of claim 19 further comprising:
an offset bend provided in said straight shank segment between said weight and said hook eye; and
a barb provided in said reverse bend, said barb spaced from said hook tip.

23. An upper center-weighted hook for partial embedment in a plastic fishing lure, said hook comprising:
a curved hook shank segment for extending into the lure;
a bend provided in one end of said curved hook shank segment;
a reverse bend terminating said bend;
a hook tip terminating said reverse bend;
a hook eye provided on an opposite end of said curved hook shank segment from said bend; and
a double-tapered weight provided on said curved shank segment, said weight spaced from said hook eye for causing said hook and the lure to sink in a waterbody.

24. The upper center-weighted hook of claim 23 further comprising:
an offset bend provided in said straight shank segment between said weight and said hook eye.

25. The upper center-weighted hook of claim 23 further comprising a barb provided in said reverse bend, said barb spaced from said hook tip.

26. The upper center-weighted hook of claim 23 further comprising:
an offset bend provided in said straight shank segment between said weight and said hook eye; and
a barb provided in said reverse bend, said barb spaced from said hook tip.

27. A fish hook comprising:
a hook shank;
a bend provided in one end of said hook shank;
a hook tip terminating said bend;
a hook eye provided on an opposite end of said hook shank from said bend; and
a weight provided on said shank between said bend and said hook eye, and having a top weight taper and a lower weight taper.

28. The fish hook of claim 27 wherein said top weight taper terminates below said hook eye.

29. The fish hook of claim 27 further comprising an offset bend positioned between said top weight taper and said hook eye, wherein said top weight taper terminates below said offset bend.

30. The fish hook of claim 27 wherein said hook shank is substantially straight from above said bend to at least immediately above said top weight taper.

31. The fish hook of claim 27 wherein said hook shank is curved from said bend at least to said lower weight taper.

32. The fish hook of claim 31 where said hook shank is curved from said bend at least to said top weight taper.

33. The fish hook of claim 27 further comprising:
an offset bend provided in said hook shank between said top weight taper and said hook eye.

34. The fish hook of claim 33 wherein said hook shank is substantially straight from above said bend to at least immediately above said top weight taper.

35. The fish hook of claim 33 wherein said hook shank is curved from said bend at least to said top weight taper.

36. The fish hook of claim 33 wherein said bend further comprises:
a reverse bend, and wherein said hook tip terminates said reverse bend.

37. The fish hook of claim 36 wherein said hook shank is substantially straight from above said bend to at least immediately above said weight.

38. The fish hook of claim 36 wherein said hook shank is curved from said bend at least to said top weight taper.

39. The fish hook of claim 36 further comprising a barb provided in said reverse bend.

40. The fish hook of claim 39 wherein said barb is spaced from said hook tip.

41. The fish hook of claim 39 wherein said hook shank is substantially straight from above said bend to at least immediately above said top weight taper.

42. The fish hook of claim 39 wherein said hook shank is curved from said bend at least to said top weight taper.

43. The fish hook of claim 27 wherein said bend further comprises:
a reverse bend, and wherein said hook tip terminates said reverse bend.

44. The fish hook of claim 43 wherein said hook shank is substantially straight from above said bend to at least immediately above said weight.

45. The fish hook of claim 43 wherein said hook shank is curved from said bend at least to said lower weight taper.

46. The fish hook of claim 43 where said hook shank is curved from said bend at least to said top weight taper.

47. The fish hook of claim 43 further comprising a barb provided in said reverse bend.

48. The fish hook of claim 47 wherein said barb is spaced from said hook tip.

49. The fish hook of claim 47 wherein said hook shank is substantially straight from above said bend to at least immediately above said weight.

50. The fish hook of claim 47 wherein said hook shank is curved from said bend at least to said top weight taper.

51. A fish hook comprising:
a straight hook shank segment;
a bend provided in one end of said straight hook shank segment;
a reverse bend terminating said bend;
a hook tip terminating said reverse bend;
a hook eye provided on an opposite end of said straight hook shank segment from said bend; and
a weight provided on said straight shank segment between said bend and said hook eye, said weight having a top weight taper and a lower weight taper.

52. The fish hook of claim 51 further comprising:
an offset bend provided in said straight shank segment between said top weight taper and said hook eye.

53. The fish hook of claim 51 further comprising a barb provided in said reverse bend.

54. The fish hook of claim 51 further comprising:
an offset bend provided in said straight shank segment between said top weight taper and said hook eye; and
a barb provided in said reverse bend.

55. A fish hook comprising:
a curved hook shank segment;
a bend provided in one end of said curved hook shank segment;
a reverse bend terminating said bend;
a hook tip terminating said reverse bend;
a hook eye provided on an opposite end of said curved hook shank segment from said bend; and
a weight provided on said curved shank segment between said bend and said hook eye, said weight having a top weight taper and a lower weight taper.

56. The fish hook of claim 55 further comprising:
an offset bend provided in said straight shank segment between said top weight taper and said hook eye.

57. The fish hook of claim 55 further comprising a barb provided in said reverse bend.

58. The fish hook of claim 55 further comprising:
an offset bend provided in said straight shank segment between said top weight taper and said hook eye; and
a barb provided in said reverse bend.
